(19) United States
(12) Patent Application Publication
(10) Pub. No.: US 2013/0192533 A1
(43) Pub. Date: Aug. 1, 2013

(54) PORTABLE DOG HOUSE

(71) Applicants: Samuel F. Lamke, Washington, MO (US); Michael C. Shine, Bloomington, MN (US)

(72) Inventors: Samuel F. Lamke, Washington, MO (US); Michael C. Shine, Bloomington, MN (US)

(73) Assignee: HKD Global Ltd., Washington, MO (US)

(21) Appl. No.: 13/749,992

(22) Filed: Jan. 25, 2013

Related U.S. Application Data
(60) Provisional application No. 61/591,623, filed on Jan. 27, 2012.

(51) Int. Cl. A01K 1/03

(52) U.S. Cl. CPC A01K 1/033
USPC 119/499

(57) ABSTRACT

A portable structure having a frame which is foldable between a stored position and a deployed position is provided in the form of a dog house. Preferably the dog house includes a peaked roof construction and the material forming the walls, floor and roof all are self-contained with the frame in the stored position and is defines the confines of the dog house in the deployed position.

### CROSS REFERENCE TO RELATED APPLICATIONS

This application claims priority to provisional U.S. application 61/591,623, the disclosure of which is incorporated herein by reference.

### STATEMENT REGARDING FEDERALLY SPONSORED RESEARCH OR DEVELOPMENT

Not Applicable.

### BACKGROUND OF THE INVENTION

In accordance with this disclosure, generally stated, a portable animal shelter is provided having a frame structure which is adaptable to a variety of configurations and sizes. While the disclosure is described in particular with respect to a portable dog house, those skilled in the art will recognize the wider applicability of the inventive constructions disclosed hereinafter.

Owners love their pets. Dog owners in particular will go to great lengths to provide comfortable accommodations for the animals in their care. While applicants' are not sure the animal appreciates the overall appearance of the structure, they are sure that aesthetic features are important in the selection of a product by the animal owner. For example, dog houses that look like a conventional house, i.e., with a sloped roof construction, are more popular than box or crate shaped structures for use by the animal. Foldable portable dog house are known in the art. However, to our knowledge, the constructions of the foldable constructions are not easily adaptable over a range of either house sizes or of house configurations. We have developed a construction which is easily adaptable to a variety of sizes and configurations.

### SUMMARY OF THE INVENTION

In accordance with this disclosure, generally stated, a foldable support structure is provided having a flexible material attached or attachable to it which can be configured, during manufacture, into a variety of size and style of structures. In the preferred embodiment, the structure resembles a house having a sloped roof. The basic frame structure however, is adaptable to a flat roof configuration. House size also is easily adjusted during manufacture to accommodate a variety of animal sizes.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a view in perspective of one illustrative embodiment of collapsible shelter of the present disclosure in its folded condition;

FIG. 2 is a view in perspective of the embodiment of FIG. 1 in an associated carry bag;

FIG. 2a is a view in perspective of the embodiment of FIG. 1 after removal of from its associated carry bag;

FIGS. 2b-2k are views in perspective of the set up procedure of the structure of the present disclosure for the embodiment of FIG. 1;

FIG. 3 is a view in perspective of the embodiment of FIG. 1 in its erected or unfolded condition;

FIG. 3A is a view in perspective of the rear side of the embodiment of FIG. 3;

FIG. 3B is an enlarged detail view in perspective taken about the line 3B of FIG. 3;

FIG. 3C is an enlarged detail view in perspective taken about the line 3C of FIG. 3;

FIG. 4 is an enlarged view, partly broken away illustrating one illustrative attachment method for attaching the roof of the structure to corresponding roof trusses for the embodiment of FIG. 1; and

FIG. 5 is an enlarged view in perspective, partly broken away of a preferred floor pad arrangement for the embodiment of FIG. 1.

Corresponding reference characters indicate corresponding parts throughout the several views of the drawings.

### DETAILED DESCRIPTION OF INVENTION

The following detailed description illustrates the invention by way of example and not by way of limitation. This description will clearly enable one skilled in the art to make and use the invention, and describes several embodiments, adaptations, variations, alternatives and uses of the invention, including what we presently believe is the best mode of carrying out the invention. As various changes could be made in the above constructions without departing from the scope of the invention, it is intended that all matter contained in the above description or shown in the accompanying drawings shall be interpreted as illustrative and not in a limiting sense.

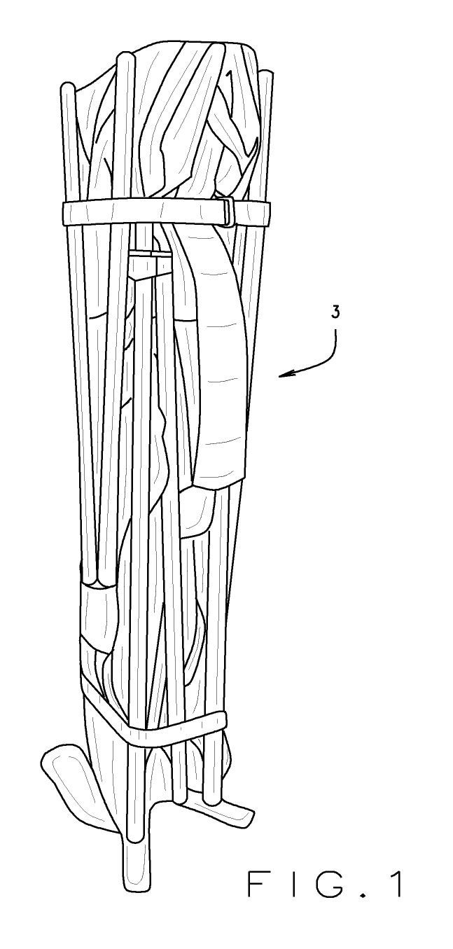

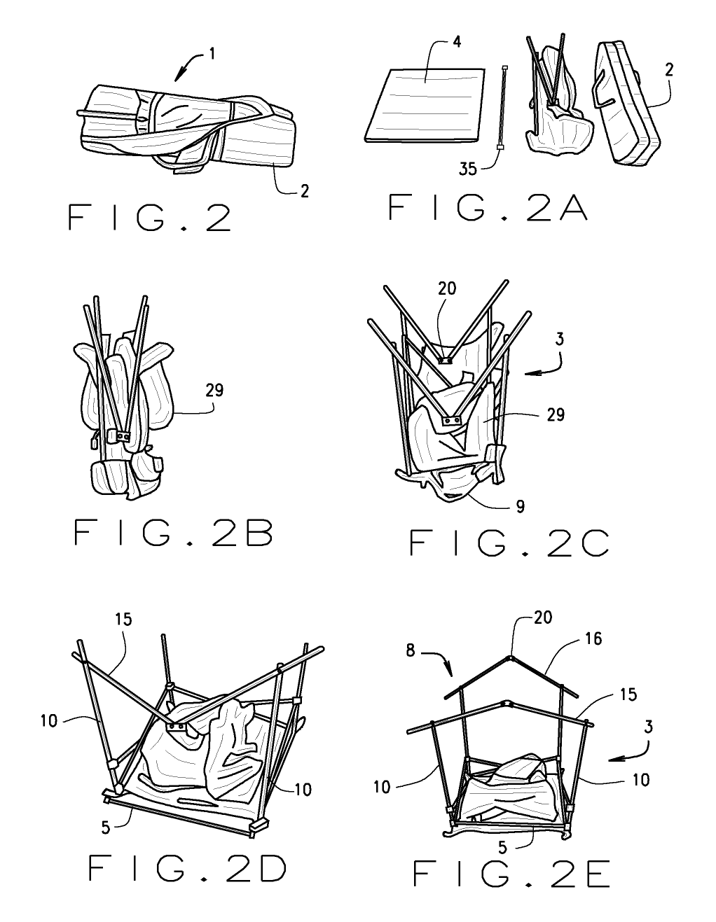

Referring now to FIGS. 1, 2, and 2A, reference numeral 1 refers to a portable structure which in the preferred embodiment includes a carry bag 2 for holding a collapsible doghouse 3, a mat 4 and a cross bar 5. The doghouse 3 includes a frame 8 and a cover 9.

The frame 8 includes a first pair of opposed leg poles 10, a second pair of opposed leg poles 11, a first foldable structure 12 extending between one of the first pair of opposed leg poles and one of the second pair of opposed leg poles, a second foldable structure 13 extending between the second one of the first pair of opposed leg poles 10 and a second one of the second pair of opposed leg poles 11, a third of foldable structure 14 extending between expect respective ones of said second pair of opposed leg poles 11; a first roof truss 15 rotatably mounted to the first pair of opposed leg poles 10, and a second roof truss 16 extending between the second pair of opposed leg pairs 11.

Each leg pole of the opposed members 10, and 11 of the frame 8 generally is similar to one another and in the embodiment illustrated all are tubular structures constructed from metal or fiberglass. Other materials are compatible the broader aspects of this disclosure.

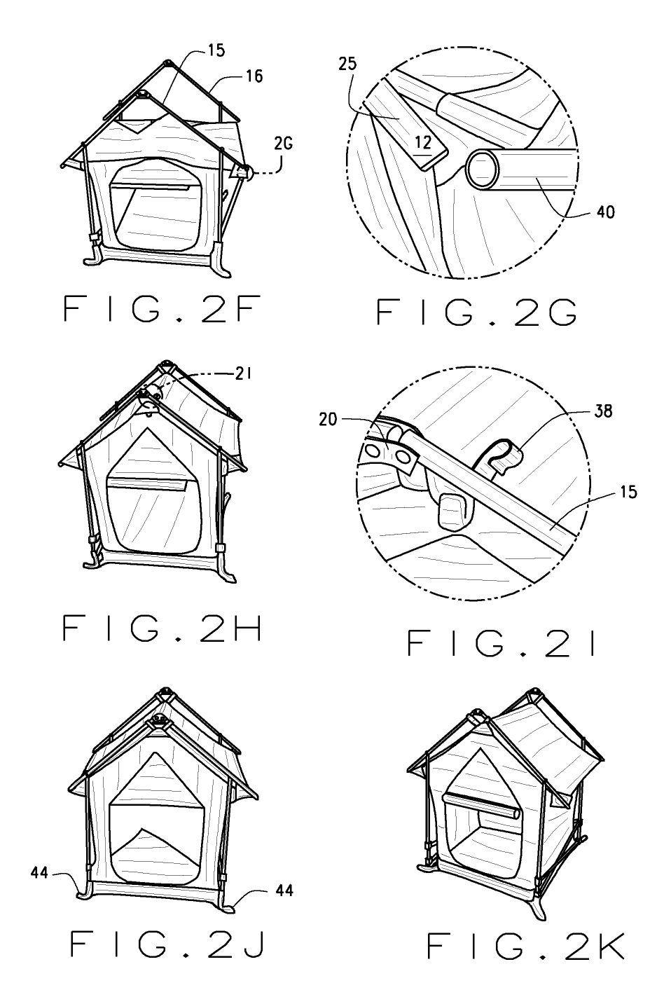

Referring now to FIGS. 3 and 3A each roof truss 15 and 16 include respective first and second arms 18 and 19 joined at their center by a pivot part 20. The second ends of each truss is also pivotally attached at 21 to a top end of the respective opposed leg poles 10 and 11, top being referenced to FIG. 3.

The foldable structures 12, 13 and 14 provide side support to the frame 8, each foldable structure has two cross members 23 and 24 respectively pivotally attached to one another along their mid-point 25. Each cross member in turn also is fixed to one of the opposed leg poles at its lower end as shown at 26 and slide ably attached to the opposite leg pole along a movable connection 27. As latter described, this frame arrangement permits the frame 8 to move easily between a compacted stored condition, as shown in FIG. 1, to the erected condition shown in FIG. 3.

The material 29 forming the walls, bottom, sides and roof of the structure 1 is an integral composite also attached to the fixed ends of the opposed side pole pairs 10 and 11. Attachment may be accomplished in any convenient method. For example, the material may be sandwiched between or riveted to the fixed ends 26. Other attachment methods will be apparent to those skilled in the art. Any suitable tent material, for example, may be used in conjunction with the frame 8 system. In any event, the front wall 30 of the structure 1 includes an entrance opening 31 and both the front wall 30 and the back wall 32 have a ventilation opening 33 formed in them.

In order to provide structural stability to the structure 1, a stability or cross bar 5 is provided with open mouth clips 35 sized to receive the respective ones of the leg poles 10. The bar 5 is attached between the leg poles 10 prior to the final deployment of the material 29 to provide the completed structure 1. While the bar 5 is shown as a clip on addition, those skill in the art will recognize that the bar 5 also can be permanently attached to the leg poles 10, provided it is constructed as a two piece part which are interconnected with a pivot part similar to the pivot part 20 employed with the roof trusses 16 and 18.

Deployment of the structure 1 from its stored condition to its operational position is illustrated in FIGS. 2 B through 2 K. As there shown, as the roof trusses are raised vertically, referenced to FIGS. 2 C and 2 D, the foldable structures 12, 13 and 14 allow the opposed leg poles 10 and 11 to expand horizontally until the bar 5 can be attached (FIGS. 2 D and 2 E). Once attached, the bar 5 stabilizes the frame 8 structure permitting the material 29 to be attached easily to the frame 8.

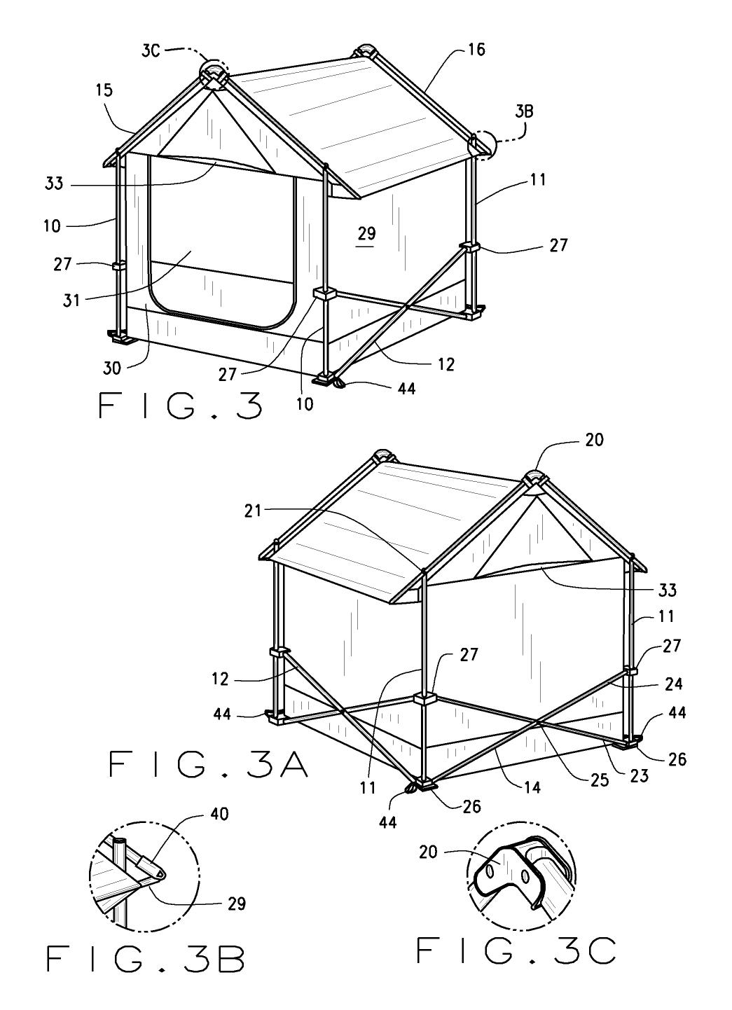

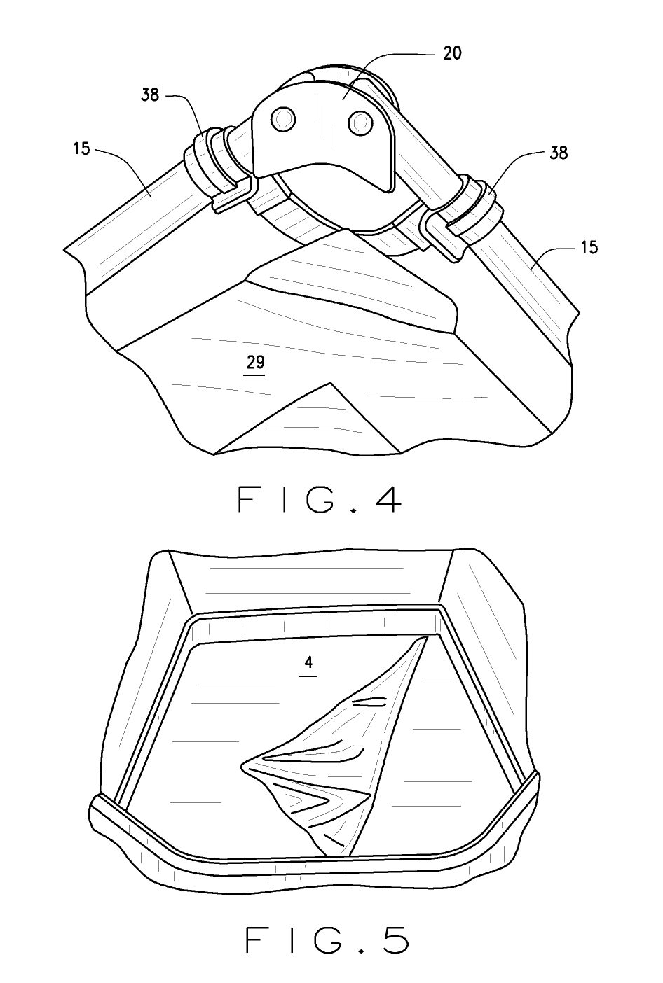

Referring to FIG. 4, the material 29 has a pair of clamps 38 attached to it at each end of the material 29 to from the desired roof pitch. The material 29 also has four corner attaching tubes 40 sized to receive the free ends 42 of the roof trusses 15 and 16 as seen in FIGS. 2 G and 3 B.

The embodiment illustrated also provides ground stake loops 44 for receiving conventional ground stakes to attach the structure 1 to the ground, if desired. Ground stakes are used in outdoor situations, commonly when camping, for example.

As will be appreciated by those skilled in the art, other embodiments of the structure 1 easily can be made. For example, merely by having the roof trusses extend between oppositely opposed ones of the leg poles 10 and 11 will convert the frame to a flat roof configuration. This configuration requires additional roof trusses and consequently addition cost for a design having less appeal to the potential customer.

After deployment of the structure 1, mat 4 is position within the structure 1 through the opening 31. The mat 4 is intended to be easily removable for cleaning or replacement.

In view of the above, it will be seen that the several objects and advantages of the present invention have been achieved and other advantageous results have been obtained. Numerous variations within the scope of the appended claims will be apparent to those skilled in the art in view of the forgoing description and accompanying drawings. Merely by way of example, the size of the structure 1 can be altered merely by changing the length of the various elements defining the frame. Likewise, various attachment techniques with respect to the material 29 and the frame 8 maybe altered in other embodiments of the structure 1. These variations are merely illustrative.

Having thus described the invention, what is claimed and desired to be secured by Letters Patent is:

1. A portable structure, comprising
a first pair of opposed leg poles;
a second pair of opposed leg poles;
a first foldable structure extending between one of the first pair of opposed leg poles and one of the second pair of opposed leg poles;
a second foldable structure extending between the second one of the first pair of opposed leg poles and second one of the second pair of opposed leg poles;
a third foldable structure extending between respective ones of said second pair of opposed leg poles;
a first pair of roof poles attached to said first pair of opposed leg poles;
a second pair of roof poles attached to said second pair of opposed leg poles; and
a connection mechanism between each of said roof poles and said leg poles adapted to permit said roof poles to move between a first close position and a second extended position.

2. The structure of claim 1 further including a material which defines the structure outline attached to said portable structure.

3. The structure of claim 1 wherein vertical movement of said roof trusses causes movement of the first, second and third moldable structures.

4. The structure of claim 2 wherein the material is attachable to said roof trusses by clips associated with the material.

5. The structure of claim 4 wherein the material is attached to the ends of the roof trusses by an attachment mechanism associated with the material.

6. The structure of claim 5 wherein the material includes at least one ventilation opening formed in it.

7. A foldable portable structure comprising:
a foldable frame arrangement including a first pair of opposed leg poles, a second pair of opposed leg poles, a plurality of foldable structures extending between respective ones of said pairs of opposed leg poles, a first roof truss having first and second parts pivotally attached to one another, each of said first and second parts be pivotally mounted to said first pair of opposed leg poles, a second roof truss having a first and a second part pivotally attached to one another, each of said first and second parts being pivotally mounted to said second pair of opposed leg poles; whereby vertical movement of said roof trusses causes movement of said respective leg poles.

8. The foldable structure of claim 7 further including a material which defines the structure outline attached to said portable structure.

9. The foldable structure of claim 8 wherein the material is attachable to said roof trusses by clips associated with the material.

10. The structure of claim 9 wherein the material is attached to the ends of the roof trusses by an attachment mechanism associated with the material.

11. The structure of claim 10 wherein the material includes at least one ventilation opening formed in it.

12. A portable folding the structure, comprising:
a frame including a plurality of roof trusses, each of said roof trusses having a first part and a second apart interconnected by a hinge mechanism, the free ends of said first and second parts being pivotally mounted to said frame so that vertical movement of said engine mechanism causes horizontal movement of said frame.

13. The portable folding the structure of claim 12 further including a first pair of opposed leg poles; a second pair of opposed leg poles, a plurality of foldable structures extending between respective ones of said pairs of leg poles, said foldable structures having at least one end slidably mounted on at least one of said leg poles.

14. The portable folding structure of claim 13 further including a material which defines the structure outline attached to said portable structure.

15. The portable folding structure of claim 14 wherein the material is attachable to said roof trusses by clips associated with the material.
